(19) United States
(12) Patent Application Publication
(10) Pub. No.: US 2017/0365193 A1
(43) Pub. Date: Dec. 21, 2017

(54) MUTABLE SECURE COMMUNICATION

(71) Applicant: Lior Malka, San Jose, CA (US)

(72) Inventor: Lior Malka, San Jose, CA (US)

(21) Appl. No.: 15/186,428

(22) Filed: Jun. 18, 2016

(51) Int. Cl. G09C 5/00; H04L 9/06

(52) U.S. Cl. CPC G09C 5/00; H04L 9/065; H04L 9/06; H04L 2209/72

(57) ABSTRACT

Secure communication provides data confidentiality, data integrity, and authentication. In one embodiment, encryption and signatures are used to construct a signcryption, which provides confidentiality and integrity. In one embodiment, an identifier and the output of a cryptographic function applied to a token are used to establish a secure channel. In one embodiment, a secure channel is mutated into a new secure channel using a renew message and a construct containing elements for establishing a secure channel.

### BACKGROUND

Cryptography provides a wide variety of functions. For example, encryption provides data confidentiality, signatures provide data integrity, and signcryption provides both. Signcryption has many applications, but existing implementations are complex, used incorrectly, and may therefore fail to deliver the required protection. Secure communication provides data confidentiality, data integrity, and authenticity. Existing communication systems use a fixed protocol or a fixed set of protocols to provide security for all users. Moreover, these protocols do not mutate as part of their normal operation. The static nature of existing communication systems makes them more susceptible to malicious traffic. To make up for this deficiency, additional hardware, software and labor is used. Consequently, existing communication systems are complex, unreliable, costly, and insecure.

### SUMMARY

Embodiments are provided for signcryption and for establishing and mutating secure channels. In one embodiment, encryption and signatures are used to produce a ciphertext that provides data confidentiality and integrity. In another embodiment, an identifier and the output of a cryptographic function applied to a token are written to a channel, verified by a receiver, and a secure channel is established using the cryptographic function. In another embodiment, a renew message is sent over a first secure channel to obtain a new construct for establishing a second secure channel, and the first secure channel is replaced with the second secure channel.

### DRAWINGS

The following figures illustrate the embodiments by way of example. They do not limit their scope.

FIG. 1 shows a flow diagram of a method of signcryption, in accordance with one embodiment.

FIG. 2 shows a flow diagram of a method of establishing a secure channel, in accordance with one embodiment.

FIG. 3 shows a flow diagram of a method of mutating a secure channel, in accordance with one embodiment.

### DETAILED DESCRIPTION

This section includes detailed examples, particular embodiments, and specific terminology. These are not meant to limit the scope. They are intended to provide clear and through understanding, cover alternatives, modifications, and equivalents.

In cryptography, encryption provides data confidentiality and signatures provide data integrity. Signcryption provides both. Some cryptographic functions have a complement. For example, encryption includes encryption and decryption, and signatures include signatures and verification. A cryptographic function is symmetric if the same key is used by its complement. For example, AES (Advanced Encryption Standard) encryption and AES decryption use the same key. A cryptographic function has a key replacement if the key is modified during operation. For example, an encryption may select a new random key at a certain frequency, encrypt the new key using the previous key, and replace the previous key with the new key. A cryptographic function has padding if a pad is affixed to the input before the function is applied. The padding may be random or fixed or computed per iteration using a function. A cryptographic composition is a cryptographic function constructed from one or more cryptographic functions. For example, a signcryption may be constructed from encryption and signatures

An object implemented using software or hardware can represent any logic, including encryption, signatures, signcryption, any cryptographic function and any cryptographic composition. Objects with similar functionality may have different implementations. For example, encryption may take a block (known as plaintext) as input and produce a block (known as ciphertext) as output, but in a stream based design, encryption takes a byte as input, and the bytes are buffered, encrypted, and written to an underlying stream. Similarly, signatures may take a block of data as input and produce a block (known as a digest) as output, but they can also be implemented as a stream. These examples extend to signcryption and other cryptographic functions. Any object can be serialized. Serialization involves the formatting of data so that it can be transmitted or stored. The serialized data, called a sequence, may have a physical representation, such as a memory, a file, a network connection, and so on. Possibly different entities, possibly in different locations, may write into and read from a sequence, at possibly different times.

Communication involves a plurality of parties. Parties may have a unique identifier and may be in different or identical locations. The location may be represented using a physical or a logical address. For example, two parties on the same device could be threads or processes, identified by a thread id or process id, respectively. The parties communicate via a channel. For example, the channel may be a TCP (Transfer Control Protocol) connection or shared memory or a file. Data sent on the channel may or may not arrive, may or may not be delayed, and may or may not be corrupted. A secure channel provides data confidentiality, data integrity, and authenticity. Elements such as identifiers, tokens, and cryptographic functions may be used to establish a secure channel. Each pair of parties may or may not have a unique channel, and elements used to establish a channel in one direction may or may not be used to establish a channel in the reverse direction. For example, if each party has unique elements for establishing a secure channel with any other party, then each channel is unique and the elements are unidirectional.

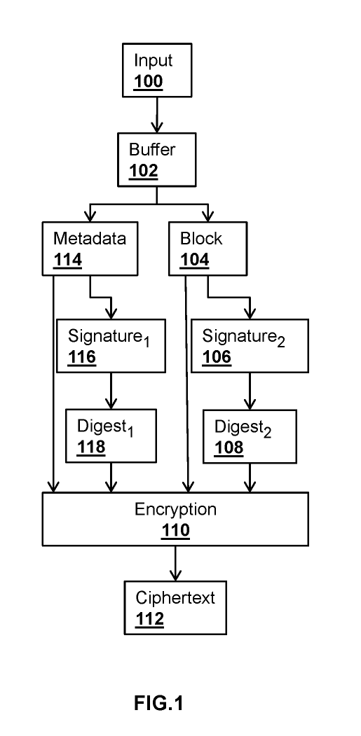

FIG. 1 shows a flow diagram of a method of signcryption, in accordance with one embodiment. The Input 100 contains data, called plaintext. The plaintext is stored in a buffer 102. When the buffer is full or flushed, a block 104 containing the plaintext and a metadata 114 describing the block are prepared. The metadata may contain the length of the block. The metadata may contain a counter that is incremented each time the block is prepared. The metadata may have a fixed length. A first signature 116 is applied to the metadata to produce a first digest 118. A second signature 106 is applied to the block to produce a second digest 108. Encryption 110 is applied to the metadata and the first digest and the block and the second digest. The encryption can be applied in any order. A ciphertext 112 produced by the encryption is outputted.

The plaintext may be recovered by reversing the above. That is, metadata and first digest are decrypted from the ciphertext, and if valid, then a block length can be determined to read block and second digest from the ciphertext, and if valid, then the block is outputted.

Any encryption can be used, including encryption that has key replacement with a certain frequency, encryption with padding, encryption that is constructed from other encryption, and encryption that is symmetric or asymmetric. Any mode of encryption may be used. Any signature can be used, whether it is keyed or not. The first signature and the second signature may be different or not. Any parameters needed, such as keys, block sizes, and frequencies, may be configurable or not, and may be included in the input 100 or not.

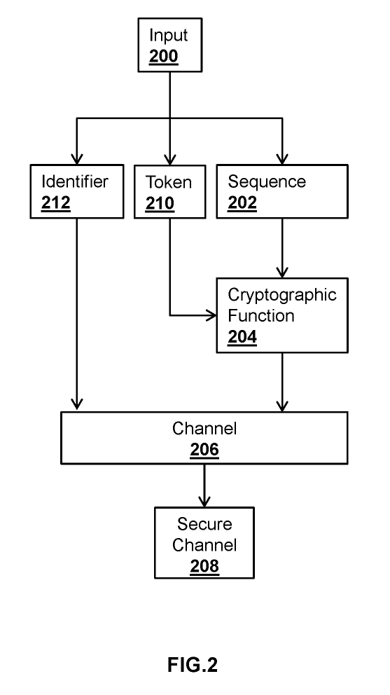

FIG. 2 shows a flow diagram of a method of establishing a secure channel, in accordance with one embodiment. The input 200 to a first party contains an identifier 212, a token 210, and a sequence 202 describing a cryptographic function 204. The input may originate in any way, including a network, a file, a database, and so on. The cryptographic function may be a signcryption. The cryptographic function is applied to the token. An output produced by applying the cryptographic function to the token is computed. The identifier and the output of the cryptographic function are sent over a channel 206 to a second party who reads the identifier from the channel. If the identifier cannot be associated with a second token and a second sequence describing a second cryptographic function, then the channel is closed. Otherwise, the second party reads a third token from the channel using the second cryptographic function. If the third token does not equal the second token, then the channel 206 is closed. Otherwise, a secure channel 208 using the cryptographic function is established. The parties may use the secure channel to communicate securely.

On the secure channel, the first party may also send to the second party a first number selected randomly. The second party replies with a second number equal to the first number. The first party closes the channel if the first number and the second number are not equal.

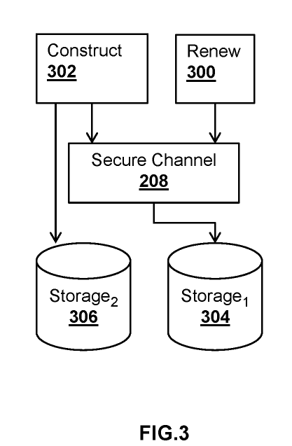

FIG. 3 shows a flow diagram of a method of mutating a secure channel, in accordance with one embodiment. A first party with a first storage 304 sends a renew message 300 via a first secure channel 208 to a second party with a second storage 306. Any storage may be used, including a memory, a file, a database, and so on. The first secure channel has been established using a first construct stored on the first storage and on the second storage. Any data may be included in the construct. For example, the data may include a first identifier or a first token or a first sequence describing a cryptographic function or combinations thereof. The first secure channel may be established in any way.

The second party replies to the renew message by generating a second construct 302 containing new versions of the elements from the first construct. For example, the second construct may include a second identifier or a second token or a second sequence describing a cryptographic function or combinations thereof. The new versions may be selected randomly.

The second party stores the second construct on the second storage and sends the second construct via the first secure channel to the first party. The first party stores the second construct on the first storage. The parties use the second construct to replace the first secure channel with a second secure channel. The second secure channel may be established immediately or later.

Each party may store more than one construct in its storage. A construct may be associated with a counter that is incremented each time a secure channel using the construct is established. A party may establish a secure channel by selecting a construct with the lowest counter. After a secure channel has been established using a construct, a party may delete from its storage all other constructs.

The specific embodiments and specific terminology used above should not be construed as limiting the scope of the embodiments. These details have been presented for purposes of illustration and are not intended to be exhaustive. Many modifications and uses are possible. The scope of the embodiments is defined by the Claims appended hereto and their equivalents.

What is claimed is:

1. A method of signcryption, the method comprising:
receiving a plaintext as input; and
buffering the plaintext to produce a block; and
producing a metadata for the block; and
producing a first digest for the metadata using a first signature; and
producing a second digest for the block using a second signature; and
producing a ciphertext by applying an encryption to the metadata and the first digest and the block and the second digest; and
outputting the ciphertext.

2. The Method of claim 1, wherein the metadata contains the length of the block.

3. The Method of claim 1, wherein the metadata contains a counter of the number of blocks produced.

4. The Method of claim 1, wherein the metadata has a fixed length.

5. The Method of claim 1, wherein at least one of first digest and second digest is not encrypted.

6. The Method of claim 1, wherein at least one of first signature and second signature is keyless.

7. The Method of claim 1, wherein the encryption has key replacement.

8. The Method of claim 1, wherein the encryption is implemented as a stream.

9. A method of establishing a secure channel, the method comprising:
receiving input containing an identifier, a token, and a sequence representing a cryptographic function; and
writing the token into the channel; and
applying the cryptographic function to the token; and
writing the output of the cryptographic function into the channel; and
outputting a secure channel using the cryptographic function.

10. The method of claim 9, wherein the cryptographic function is a signcryption.

11. The method of claim 9, wherein at least one of the identifier and the token contain at least 64 bytes.

12. The method of claim 9, further comprising sending a randomly selected first number on the secure channel and closing the channel if a second number equal to the first number is not sent in response.

13. A method of mutating a secure channel, the method comprising:
sending over a first secure channel a renew message from first party with a first storage to a second party with a second storage; and
generating using random values a construct containing elements used to establish the first secure channel; and
storing the construct on the second storage; and
sending the construct over the first secure channel from the second party to the first party; and
storing the construct on the first storage; and
replacing the first secure channel with a second secure channel using elements from the second construct.

14. The method of claim 13, wherein the construct contains an identifier, a token, and a sequence representing a signcryption.

15. The method of claim 12, wherein replacing the first secure channel with a second secure channel using elements from the second construct occurs immediately after storing the construct on the first storage.

16. The method of claim 12, wherein the construct is associated with a counter that is incremented each time a secure channel is established.

17. The method of claim 12, further comprising removing from first storage and second storage all constructs not used to establish the secure channel.
